(19) United States
(12) Patent Application Publication
(10) Pub. No.: US 2003/0038750 A1
(43) Pub. Date: Feb. 27, 2003

(54) Indented planar inverted F-type antenna

(75) Inventor: Tailee Chen, Taipei (TW)

Correspondence Address: DOUGHERTY & TROXELL, SUITE 1404, 5205 LEESBURG PIKE, FALLS CHURCH, VA, 22041, US

(73) Assignee: GemTek Technology Co., Ltd.

(21) Appl. No.: 10/044,980

(22) Filed: Jan. 15, 2002

(30) Foreign Application Priority Data
Aug. 24, 2001 (TW) 90120960

(51) Int. Cl. H01Q 1/26; H01Q 1/24

(52) U.S. Cl. 343/700 MS; 343/702

(57) ABSTRACT

An indented planar inverted F-type antenna apparatus comprises a metal ground plane having a feeding metal bore formed thereon and a crenellated metal in parallel with the metal ground plane. The crenellated metal further has an open-circuit end and a short-circuit end. The short-circuit end can connect with the metal ground plane through a short-circuit leg. Further, the crenellated metal can include a feeding leg for extending to pass through the feeding metal bore. By providing the crenellated structure of the crenellated metal, the size of the antenna can be reduced and an irregular electric field can be generated between the crenellated metal and the metal ground so that various frequencies of signals can be obtained and also operating frequency band of the antenna can be extended.

### FIELD OF THE INVENTION

The present invention relates to a planar inverted F-type antenna and more particularly to an indented planar inverted F-type antenna that increase the operating frequency band and reduce the size of antenna.

### BACKGROUND OF THE INVENTION

In recent years, rapid innovation and development of wireless communication technology have created a variety of communication products. Among them, mobile communication products that combine 3C technology and communication modules are obvious one kind of the main streams products in the market. These mobile communication products include notebook computers, PDAs, Palms, etc. Most of them can be coupled with proper communication modules for linking LAN (Local Area Network), transmitting/receiving e-mail, and receiving in-time information (such as news, stocks quotations and so on) to share resources and information. Particularly, the planar inverted F-type antennas for example have advantages in compact sizes and lightweight over traditional antenna products, and thus have been widely adopted as built-in antennas for the mobile communication products.

Referring to FIG. 1 for a planar inverted F-type antenna in the prior art, the antenna includes a metal ground plane 10, a flat metal plate 12, a short-circuit leg 14, and a feeding leg 16. The metal ground plane 10 in parallel with the flat metal plate 12 further has a feeding metal bore 15. The short-circuit leg 14 and the feeding leg 16 are located respectively at one side of the flat metal plate 12. The short-circuit leg 14 as shown is used to connect the metal ground 10 and the flat metal plate 12. On the other hand, the feeding leg 16 extended from the flat metal plane 12 is used to pass through the feeding metal bore 15 for further connecting to a matching circuit (not shown in the drawing). The flat metal plate 12, formed as a rectangular thin sheet, has a short-circuit end providing the short-circuit leg 14 and an opposing open-circuit end distant to the short-circuit leg 14. The distance of the flat metal plane 12 measured from the open-circuit end to the short-circuit end is about a quarter of wavelength.

The size of antenna shown in FIG. 1 is restricted by the practice that the length of flat metal plate 12 is about a quarter wavelength. Therefore, little room and change can be utilized to vary the size of antenna.

Though it is an obvious trend that the size of the passive components in the integrated circuit can be produced smaller and smaller, yet the trend does not contribute much to reduce the size of the antenna for communication products due to the wavelength limitation. Actually, not only the size of the antenna is limited, but also the application frequency as well as the operating frequency bandwidth thereof is confined.

Therefore, manufacturers of the planar inverted F-type antenna have devoted a lot of research and development efforts to extending the operating frequency band and to reducing the size of the antenna.

### SUMMARY OF THE INVENTION

Accordingly, the primary object of the invention is to provide an indented planar inverted F-type antenna for reducing the size of the antenna.

Another object of the invention is to provide an indented planar inverted F-type antenna for increasing the operating frequency band of the antenna.

A further object of the invention is to provide an indented planar inverted F-type antenna for symmetrical radiation pattern in order to enhance cover range while either transmitting or receiving data.

According to a first embodiment of the invention, the antenna includes a metal ground plane, a flat metal plate, a short-circuit leg, a feeding leg, and a feeding metal bore. The flat metal plate has an open-circuit end and a short-circuited end, and forms an open-short circuit structure that has a length about a quarter of wavelength.

The feeding leg passing through the feeding metal bore can be soldered to a matching circuit at a lower surface of the flat metal plate by a central symmetrical style to both sides of the flat metal plate. The short-circuit end of the flat metal plate connects with the metal ground plane through the short-circuit leg. On the other hand, the open-circuit end having two chamfers forms a W-shaped structure that contributes to change the length of the current route so as to allow the antenna capable of receiving signals with various frequencies and increasing the operating frequency band of the antenna.

A second embodiment of the invention is largely similar to the first embodiment discussed previously. In this embodiment, both sides of the flat metal plate are formed as indented structures for the indented sides that contribute to increase the length of the current route. By controlling the length of the feeding current route, the size of the antenna may thus be variable.

The indented sides of the flat metal plate can vary the length of the current route so as to allow the antenna to receive signals of various frequencies and to increase operating frequency band of the antenna.

According to a third embodiment of the invention, the antenna includes a metal ground plane, a crenellated metal, a short-circuit leg, a feeding leg, and a feeding metal bore. The crenellated metal by folding from a flat metal plate in the art has an open-circuit end and a short-circuit end which connects with the metal ground plane through the short-circuit leg. The feeding leg can be soldered, at one end, to a lower surface of the crenellated metal by a central symmetrical style to both sides of the crenellated metal, and further extend to pass through the feeding metal bore for connecting to a matching circuit at a lower surface of the metal ground plane.

In the present invention, the crenellated structure possesses an equivalent quarter-wavelength open-short circuit that is shorter than the conventional prior art, so that the size of the antenna can be reduced. Besides, the disturbed electric field caused by the crenellated structure can lead to more wider operating frequency band.

### BRIEF DESCRIPTION OF THE DRAWINGS

The present invention will now be specified with reference to its preferred embodiments illustrated in the drawings, in which

FIG. 1 is a schematic perspective view of a conventional planar inverted F-type antenna;

FIG. 2 is a schematic perspective view of a first embodiment of the invention;

FIG. 3 is a schematic perspective view of a second embodiment of the invention; and

FIG. 4 is a schematic perspective view of a third embodiment of the invention.

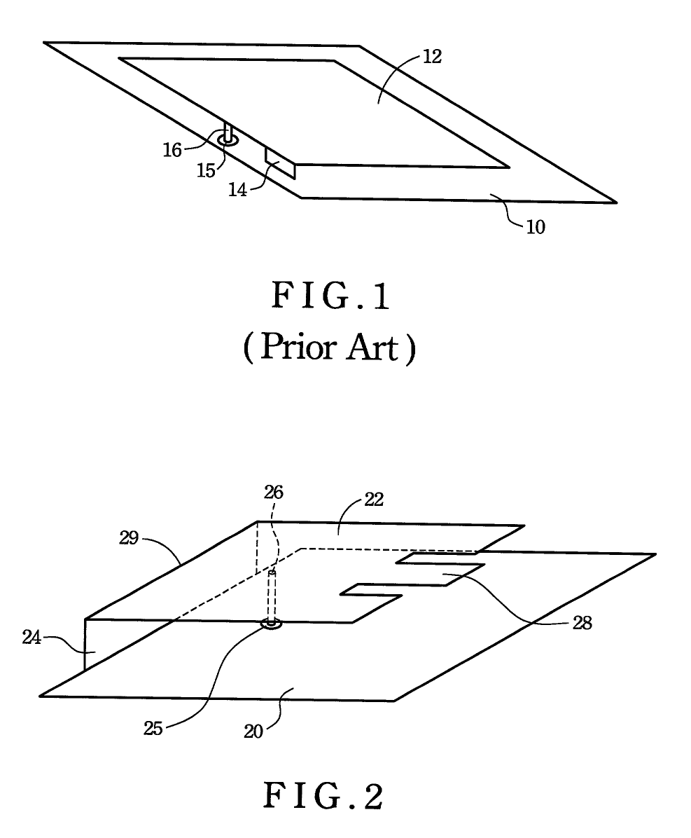

### DESCRIPTION OF THE PREFERRED EMBODIMENT

The invention aims at providing an indented planar inverted F-type antenna. The antenna that size of the antenna is smaller than the size of the conventional techniques makes the communication products small, and the operating frequency band of the antenna is wider than that of previous technique.

Referring now to FIG. 2 for a first embodiment of the invention, the antenna includes a metal ground plane 20, a flat metal plate 22 in parallel with the metal ground plane 20, a grounded short-circuit leg 24, a feeding leg 26, and a feeding metal bore 25 formed on the metal ground plane 20. The flat metal plate 22 provides an open-circuit end 28 and an opposing short-circuit end 29 which connect electrically with the metal ground plane 20 through the short-circuit leg 24. The feeding leg 26 can be soldered, at one end thereof, to the flat metal plate 22 at a lower surface by a central symmetrical style to both lateral sides of the flat metal plate 22. Another end of the feeding leg 26 is extended to pass through the feeding metal bore 25 for connecting with a matching circuit (not shown in the drawing) without connecting with the metal ground plane 20.

The flat metal plate 22 formed as an open-circuit and short-circuit structure has a length about a quarter wavelength from the open-circuit end 28 to the short-circuit end 29. The open-circuit end 28 as shown has two chamfers to form a W-shaped structure that is used to make different paths of currents and thus to increase the operating frequency band of the antenna.

In this embodiment, the feeding leg 26 is located in the center on the lower surface of the flat metal plate 22 and is symmetrical to two lateral sides of the flat metal plate 22 so that, while signals are fed, the current will be transmitted symmetrically on the flat metal plate 22 to generate a symmetric radiation field.

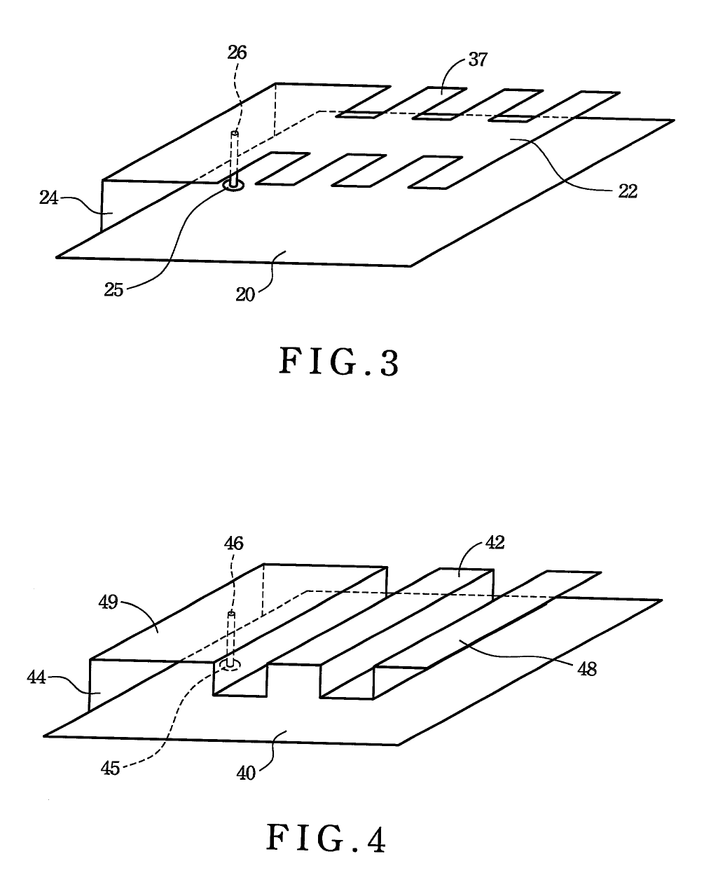

FIG. 3 shows a second embodiment of the invention that is largely similar to the first embodiment previously discussed. Similar elements will be marked by similar numerals. Different features and functions will be discussed below while similar structures and functions will be omitted. As shown, both lateral sides 37 of the flat metal plate 22 are formed as indented structures for the indented sides 37 can increase the length of the current route. By controlling the length of the current route, the size of the antenna can be reduced effectively.

The indented side 37 of the flat metal plate 22 varies the length of the current routes to allow the antenna to increase the operating frequency band. The feeding leg 26 is located in the center on the lower surface of the flat metal plate 22 and is symmetrical to both lateral sides 37 of the flat metal plate 22. Upon such an arrangement, a symmetric radiation field on the flat metal plate 22 can be generated.

FIG. 4 shows a third embodiment of the invention, in which the antenna includes a metal ground plane 40, a crenellated metal 42 in parallel with the metal ground plane 40, a grounded short-circuit leg 44, a feeding leg 46, and a feeding metal bore 45 formed on the metal ground plane 40. The crenellated metal 42 that can be manufactured by folding a flat metal plate of the conventional techniques has an open-circuit end 48 and a short-circuit end 49 which connects the metal ground plane 40 through the short-circuit leg 44. The feeding leg 46 is soldered to the crenellated metal 42 at a lower surface in a center symmetrical to two lateral sides of the crenellated metal 42, and the feeding leg 46 passing through the feeding metal bore 45 is further connected to a matching circuit (not shown in the drawing) under the metal ground plane 40, but does not contact the metal ground plane 40.

In the third embodiment, the crenellated metal 42 can be folded from a flat metal plate of the conventional techniques. The crenellated metal provides a shorter equivalent quarter wavelength than the conventional planar inverted F-type antenna. Thus, the linear distance between the open-circuit end 48 and the short-circuit end 49 is shorten and thereby the size of the antenna is effectively reduced.

Because the distance between the crenellated metal 42 and the metal ground plane 40 is not a constant, it can generate irregular electric field beneath the crenellated metal 42 and can increase the operating frequency band.

In summary, the present invention provides following advantages over the conventional techniques:

a. the current route of the invention can be changed by different shapes of the flat metal plate so as to reduce the size of the antenna.

b. The crenellated metal of the invention can be folded from the flat metal plate to reduce the size of the antenna to improve the operating frequency band of the antenna.

c. The feeding leg of the invention is located in the center below the flat metal plate and is symmetrical to two lateral sides on the surface. Therefore, a symmetrical radiation field can be generated. Thus, this present invention can meet requirement of applications of symmetrical radiation pattern.

While the preferred embodiments of the invention have been set forth for purpose of disclosure, modifications of the disclosed embodiments of the invention as well as other embodiments thereof may occur to those skilled in the art. Accordingly, the appended claims are intended to cover all embodiments that do not depart from the spirit and scope of the invention.

What is claimed is:

1. An indented planar inverted F-type antenna, comprising:
a metal ground plane, having a feeding metal bore formed thereon; and
a flat metal plate in parallel with the metal ground plane, having thereof an open-circuit end and a short-circuit end, the short-circuit end being electrically connected to the metal ground plane through a short-circuit leg, the flat metal plate further having thereof a feeding leg protruding to pass through the feeding metal bore;
wherein a distance of the flat metal plate measured from the open-circuit end to the short-circuit end is substantially equal to a quarter of a predetermined wavelength, and the open-circuit end has at least one chamfered structure thereof extending inwards.

2. The indented planar inverted F-type antenna of claim 1, wherein said feeding leg is not connected with said metal ground plane.

3. The indented planar inverted F-type antenna of claim 2, wherein said feeding leg is located symmetrically with respect to lateral sides of said flat metal, so that said the antenna is able to produce a symmetrical radiation field.

4. The indented planar inverted F-type antenna of claim 1, wherein said feeding leg is soldered to a lower surface of said flat metal plate.

5. The indented planar inverted F-type antenna of claim 1, wherein said feeding leg connects electrically to a matching circuit for generating matching impedance.

6. An indented planar inverted F-type antenna, comprising:
a metal ground plane, having a feeding metal bore formed thereon; and
a flat metal plate in parallel with the metal ground plane, having thereof an open-circuit end and a short-circuit end, the short-circuit end being connected with the metal ground plane through a short-circuit leg, the flat metal plate further having a feeding leg extending to pass through the feeding metal bore;
wherein the flat metal plate has at least a side thereof forming an indented structure.

7. The indented planar inverted F-type antenna of claim 6, wherein said flat metal plate has both sides thereof forming two said indented structure.

8. The indented planar inverted F-type antenna of claim 6, wherein said feeding leg is not connected with said feeding leg is not connected with said metal ground plane.

9. The indented planar inverted F-type antenna of claim 6, wherein said feeding leg is soldered to a lower surface of said flat metal plate.

10. The indented planar inverted F-type antenna of claim 6, wherein the feeding leg connects electrically to a matching circuit for generating matching impedance.

11. An indented planar inverted F-type antenna, comprising:
a metal ground plane, having a feeding metal bore formed thereon; and
a crenellated metal in parallel with the metal ground plane, having thereof an open-circuit end and a short-circuit end, the short-circuit end being connected with the metal ground plane through a short-circuit leg, the crenellated metal further having a feeding leg protruding to pass through the feeding metal bore;

12. The indented planar inverted F-type antenna of claim 12, wherein said feeding leg is not connected with said metal ground plane.

13. The indented planar inverted F-type antenna of claim 12, wherein the type of said crenellated metal can be square-wave type, triangle-wave type, and smooth wave type.

14. The indented planar inverted F-type antenna of claim 12, wherein said feeding leg connects electrically to a matching circuit for generating matching impedance.
